(19) United States
(12) Patent Application Publication
(10) Pub. No.: US 2013/0283970 A1
(43) Pub. Date: Oct. 31, 2013

(54) BICYCLE DRIVE ASSEMBLY

(71) Applicant: Wen-Feng TSAI, Taichung City (TW)

(72) Inventor: Wen-Feng TSAI, Taichung City (TW)

(73) Assignee: Tien Hsin Industries Co., Ltd., Taichung City (TW)

(21) Appl. No.: 13/524,145

(22) Filed: Jun. 15, 2012

(30) Foreign Application Priority Data
Apr. 30, 2012 (TW) 101208099

(51) Int. Cl. B62M 3/00

(52) U.S. Cl. 74/594.1

(57) ABSTRACT

A bicycle drive assembly includes a spindle installed in a bicycle, a first crank arm and a second crank arm respectively mounted at two distal ends of the spindle, the first crank arm being rotatable on the axis of the spindle in a first direction of rotation to drive the bicycle forwards, the first crank arm being fastened to the spindle by a screw joint in a second direction of rotation that is the same direction of the first direction of rotation to ensure tight connection between the first crank arm and the spindle when the user is riding the bicycle to pedal the first crank arm.

### BACKGROUND OF THE INVENTION

1. Field of the Invention

The present invention relates to a bicycle drive assembly and more particularly, to a bicycle crankset mounting structure having the characteristics of simple structure, ease of installation and high level of installation stability.

2. Description of the Related Art

Bicycle is an implement popularly accepted by people for sports and transportation. A user simply needs to pedal the pedals, creanksets will be driven to rotate the chainring and the chain in moving the wheels of the bicycle, and therefore the bicycle can be moved forwards.

As stated above, a bicycle drive assembly comprises at least a spindle pivotally mounted in the bicycle frame, a pair of crank arms respectively mounted at the two distal ends of the spindle and rotatable on the axis of the spindle, a chainring mounted at one crank arm and rotatable on the axis of the spindle, and a pair of pedals respectively pivotally connected to the crank arms remote from the spindle.

To ensure bicycle riding stability, the connection between the spindle and the crank arms must be tight. Therefore, a conventional bicycle drive assembly may provide positioning teeth between the spindle and the crank arm to prevent relative rotation between the spindle and the crank arm, and a screw bolt or pin to provide a locking function. However, this method increases the amount of component parts and cost, and complicates the installation procedure. Further, this method still cannot eliminate the problem of looseness in the crank arm. An improvement in this regard is necessary.

### SUMMARY OF THE INVENTION

The present invention has been accomplished under the circumstances in view. It is the main object of the present invention to provide a bicycle drive assembly, which has the characteristics of simple structure and ease of installation.

It is another object of the present invention to provide a bicycle drive assembly, which avoids component loosening.

To achieve these and other objects of the present invention, a bicycle drive assembly comprises a spindle installed in a bicycle, and a first crank arm and a second crank arm respectively mounted at two distal ends of the spindle. The first crank arm is rotatable on the axis of the spindle in a first direction of rotation to drive the bicycle forwards, and fastened to the spindle by a screw joint in a second direction of rotation that is the same direction of the first direction of rotation.

Thus, when the user is riding the bicycle, the direction in which the first crank arm is threaded onto the spindle is same as the direction of rotation of the bicycle driven by the first crank arm. Therefore, the user's foot will continuously apply a pressure to the first crank arm when riding the bicycle, rotating the first crank arm in the direction for fixing to the spindle, enhancing connection stability and avoiding loosening between the first crank arm and the spindle.

Further, in a preferred embodiment of the present invention, the first direction of rotation and the second direction of rotation are clockwise direction when viewed from one side of the first crank arm opposite to the spindle, and therefore right-hand thread can be used. Further, a packing member can be set between the spindle and the first crank arm to enhance the connection stability, preventing the first crank arm from an axial displacement along the spindle.

### BRIEF DESCRIPTION OF THE DRAWINGS

FIG. 1 is an exploded view of a bicycle drive assembly in accordance with the present invention.

FIG. 2 is an elevational assembly view of the bicycle drive assembly in accordance with the present invention.

FIG. 3 is a sectional view of the bicycle drive assembly in accordance with the present invention.

### DETAILED DESCRIPTION OF THE INVENTION

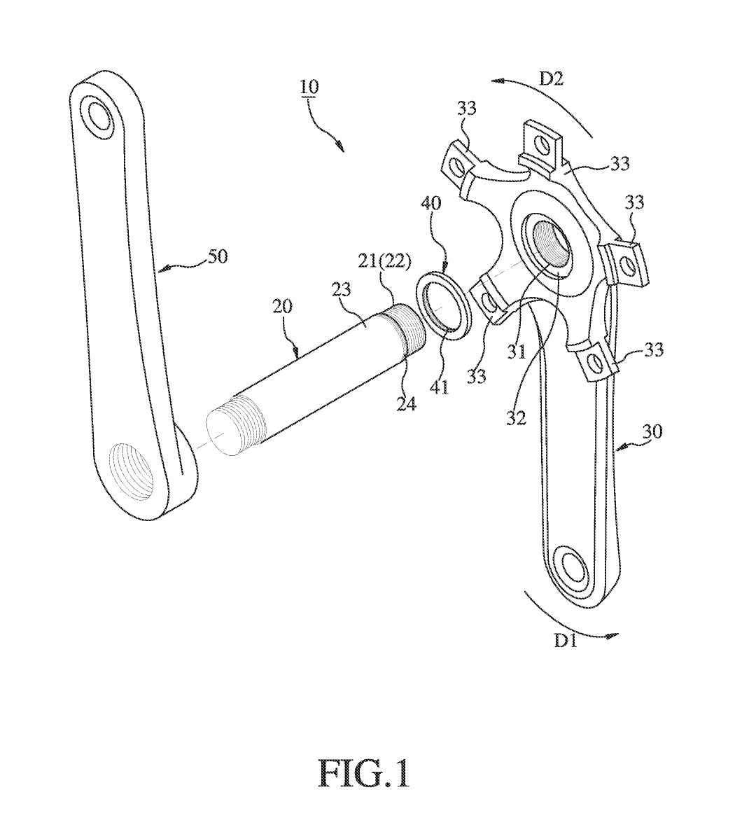

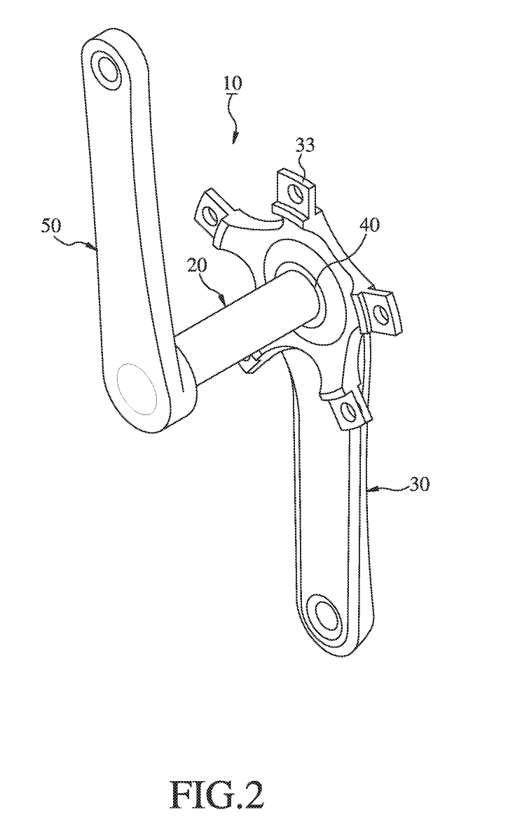

Referring to FIGS. 1-3, a bicycle drive assembly 10 in accordance with the invention is shown. The bicycle drive assembly 10 comprises a spindle 20, a first crank arm 30 and a second crank arm 50 mounted at two distal ends of the spindle 20, and a packing member 40. The first crank arm 30 is connected to one end of the spindle 20 and rotatable in a first direction of rotation D1 to drive a bicycle (not shown) forwards. In this embodiment, the first direction of rotation D1 is the clockwise direction when viewed from one side of the first crank arm 30 opposite to the spindle 20. The structures of these component parts are outlined hereinafter.

The end of the spindle 20 adjacent to the first crank arm 30 is a connection end 21, which comprises a first outer thread 22. Further, the spindle 20 comprises a segment 23 disposed adjacent to the connection end 21 and having a diameter greater than the connection end 21. Further, a second outer thread 24 is disposed at the segment 23 adjacent to one side of the connection end 21.

The first crank arm 30 comprises a first screw hole 31 corresponding to the first outer thread 22 so that the first crank arm 30 can be threaded onto the spindle 30 in a second direction of rotation D2. In this embodiment, the second direction of rotation D2 and the first direction of rotation D1 are the clockwise direction when viewed from one side of the first crank arm 30 opposite to the spindle 20. Further, the first outer thread 22 is a right-hand thread. Further, the first crank arm 30 has a groove 32 located on one side thereof adjacent to the spindle 20 in a concentric manner relative to the first screw hole 31, and five radially extended mounting portion 33 for the mounting of a chainring (not shown).

The packing member 40 comprises a second screw hole 41 corresponding to the second outer thread 24. The connection end 21 is inserted through the second screw hole 41, enabling the second screw hole 41 to be threaded onto the second outer thread 24 of the spindle 20. When threading the first crank arm 30 onto the spindle 20, the packing member 40 will be accommodated in the groove 32 secured between the spindle 20 and the first crank arm 30.

The second crank arm 50 is threaded onto the other end of the spindle 20 opposite to the connection end 21.

Thus, as shown in FIG. 1, in the present preferred embodiment, the installation of the first crank arm 30 is done by: sleeving the packing member 40 onto the spindle 20 over the connection end 21 and then threading the second screw hole 41 onto the second outer thread 24 of the spindle 20, and then threading the first crank arm 30 onto the connection end 21 of the spindle 20 in the second direction of rotation D2 by means of the first screw hole 31 and the first outer thread 22. When fastening tight the first crank arm 30, the packing member 40 is held down in the groove 32 of the first crank arm 30. Thus, the assembly process of the bicycle drive assembly 10 is done conveniently and rapidly.

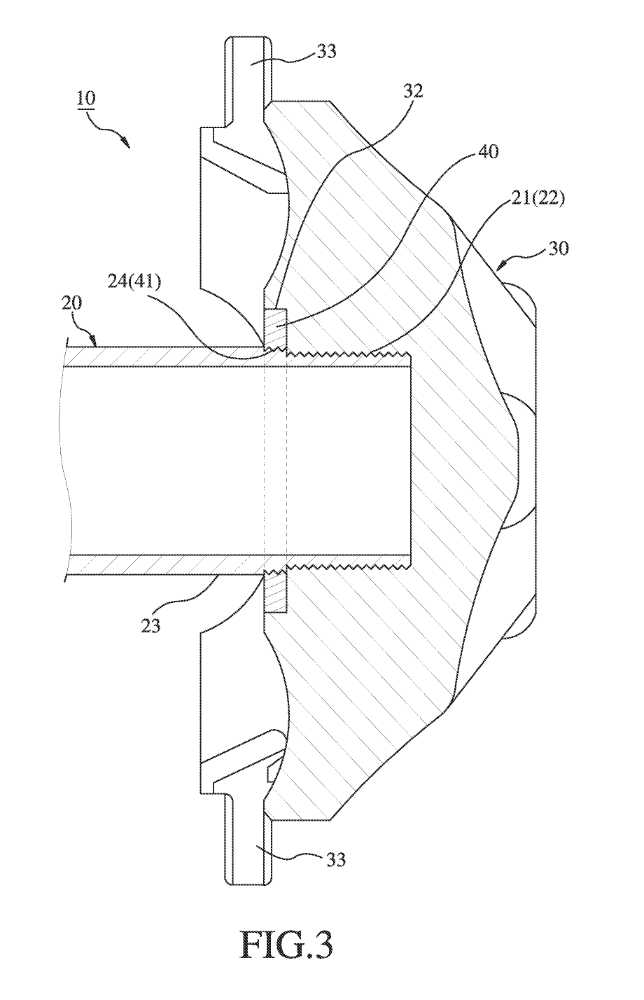

Referring to FIG. 3, fitting between the packing member 40 and the groove 32 not only enhances connection stability between the spindle 20 and the first crank arm 30 but also stops the first crank arm 30 against axial displacement relative to the spindle 20.

According to the bicycle drive assembly 10 of the present invention, the direction in which the first crank arm 30 is threaded onto the spindle 20 is same as the direction of rotation of the bicycle driven by the first crank arm 30. Therefore, the user's foot will continuously apply a pressure to the first crank arm 30 when riding the bicycle, rotating the first crank arm 30 in the direction for fixing to the spindle 20, enhancing connection stability and avoiding looseness between the first crank arm 30 and the spindle 20.

It is to be noted that the direction of rotation of the first crank arm 30 and the design of the threads in the above stated preferred embodiment is simply an example of the present invention. Any person skilled in the art can make simple modifications without departing from the spirit and scope of the invention. For example, the direction of rotation of the second crank arm 50 can be changed to the counter-clockwise direction. Further, the design of the packing member 40, which is adapted to enhance connection tightness and the positioning of the first crank arm 30, and design of the the segment 23 of the spindle 20, which is adapted to fit the packing member 40, are not within the scope of the technical features of the present invention, no further detailed description in this regard is necessary. In conclusion, the bicycle drive assembly of the present invention has the characteristics of simple structure, ease of installation and high level of installation stability, enabling the user to enjoy the fun of bicycle riding without worrying about loose crank arm and spindle.

What is claimed is:

1. A bicycle drive assembly, comprising a spindle installed in a bicycle, a first crank arm and a second crank arm respectively mounted at two distal ends of said spindle, said first crank arm is rotatable on the axis of said spindle in a first direction of rotation to drive said bicycle forwards, wherein:
said first crank arm is fastened to said spindle by a screw joint in a second direction of rotation, said second direction of rotation is the same as said first direction of rotation.

2. The bicycle drive assembly as claimed in claim 1, wherein said first crank arm comprises a first screw hole; said spindle comprises a connection end disposed at one end thereof adjacent to said first crank arm, and a first outer thread located on said connection end and threaded into said first screw hole.

3. The bicycle drive assembly as claimed in claim 1, wherein said first direction of rotation and said second direction of rotation are clockwise direction when viewed from one side of said first crank arm opposite to said spindle.

4. The bicycle drive assembly as claimed in claim 2, wherein said first crank arm comprises a plurality of mounting portion for the mounting of a chainring.

5. The bicycle drive assembly as claimed in claim 2, further comprising a packing member set between said spindle and said first crank arm.

6. The bicycle drive assembly as claimed in claim 5, wherein said first crank arm comprises a groove located on one side thereof adjacent to said spindle; said spindle comprises a segment disposed adjacent to said connection end, the diameter of said segment is larger than said connection end; said packing member is fitted onto said segment in such a manner that said packing member is accommodated in said groove when said first crank arm is fastened to said spindle.

7. The bicycle drive assembly as claimed in claim 6, wherein said segment comprises a second outer thread; said packing member comprises a second screw hole threaded onto said second outer thread.
